(19) United States
(12) Patent Application Publication
(10) Pub. No.: US 2016/0345565 A1
(43) Pub. Date: Dec. 1, 2016

(54) FISHING FLOAT

(71) Applicant: Bryan Gilmartin, Wilmington, OH (US)

(72) Inventor: Bryan Gilmartin, Wilmington, OH (US)

(21) Appl. No.: 15/154,274

(22) Filed: May 13, 2016

Related U.S. Application Data
(60) Provisional application No. 62/168,950, filed on Jun. 1, 2015.

(51) Int. Cl. A01K 93/02; A01K 97/12

(52) U.S. Cl. CPC A01K 93/02; A01K 97/125

(57) ABSTRACT

A fishing float which is particularly useful for nighttime fishing includes a top section including a light; a hollow middle section including an optional removable weight and a bottom section. First and second conductors extend from said light through the middle section to first and second portal in said bottom section. When the first and second conducting wires are exposed to water, the light is activated. The light is deactivated at a defined period of time after the float is removed from water. The bottom section may also include stored first and second plugs which are designed to plug the first and second portals to prevent the light from being activated when the float is in the water so that the float can be used without wasting battery power during the daytime.

### RELATED APPLICATION

The present application claims priority to U.S. Ser. No. 62/168,950 filed Jun. 1, 2015, the disclosure of which is hereby incorporated herein by reference in its entirety.

### BACKGROUND OF THE INVENTION

Fishing at night can be both rewarding and challenging. Determining the position of the fishing line can be quite difficult. Therefore, many different fishing devices, such as floats and the like, incorporate some sort of light. These may be, for example, a chemical glow stick or a battery-powered light. Many of these devices have relatively limited utility and maybe expensive to operate.

### SUMMARY OF THE INVENTION

The present invention provides a fishing float which has a light which is activated when the float contacts water and deactivated when the float is removed from water.

According to one embodiment of the present invention, the float further includes a timing circuit which keeps the light on the float activated for a defined period of time after the float is removed from the water. Thus, if the fisherman pulls the float out and recasts, the light will stay on as the fisherman recasts.

In another embodiment of the present invention, the lighted fishing float is activated by one or two wires that contact the water. The contacts can be located in recesses and the float itself can include plugs that can be placed into the recesses so that the fishing float is activated only when desired. For example, the float can be used during the daylight without activating the lights and draining the battery.

In a further embodiment of the present invention, the lighted fishing float is powered by a battery and the float includes a charging port which is accessed only after disassembling a portion of the of the float to expose the charging port.

The float can be a cigar style, slip line float which includes top, middle and bottom portions, the bottom portion being removable to allow a cylindrical weight to be inserted within the middle portion of the float, allowing fisherman to adjust the weight of the float.

Further, the present invention can include a cigar style float which has a top, middle and bottom section, wherein the top section is separable from the middle section and a tube extends from a top opening in the top of the float through the middle and bottom sections to provide a passage for the fishing line without allowing water to access any of the electrical components of the float. The bottom section is removable to allow placement of a separate weight within the center portion of the float.

The objects and advantages of the invention will be further appreciated in light of the following detailed descriptions and drawings.

### BRIEF DESCRIPTION OF THE DRAWINGS

FIG. 1 is perspective view of the present invention;

FIG. 2 is an exploded view of an upper portion of the float shown in FIG. 1;

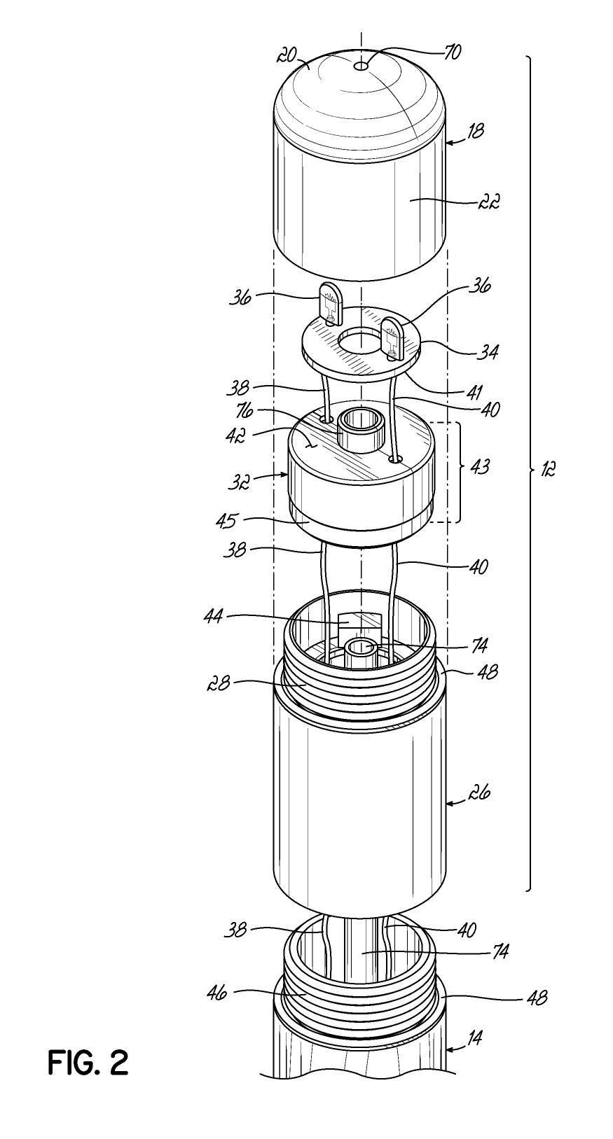

FIG. 3 is an exploded view of a lower portion of the float shown in FIG. 1;

FIG. 4 is a cross-sectional view taken along 4-4 at FIG. 1;

FIG. 5 is a cross-sectional view taken lines 5-5 of FIG. 1; and

FIG. 6 is a circuit diagram.

### DETAILED DESCRIPTION OF THE INVENTION

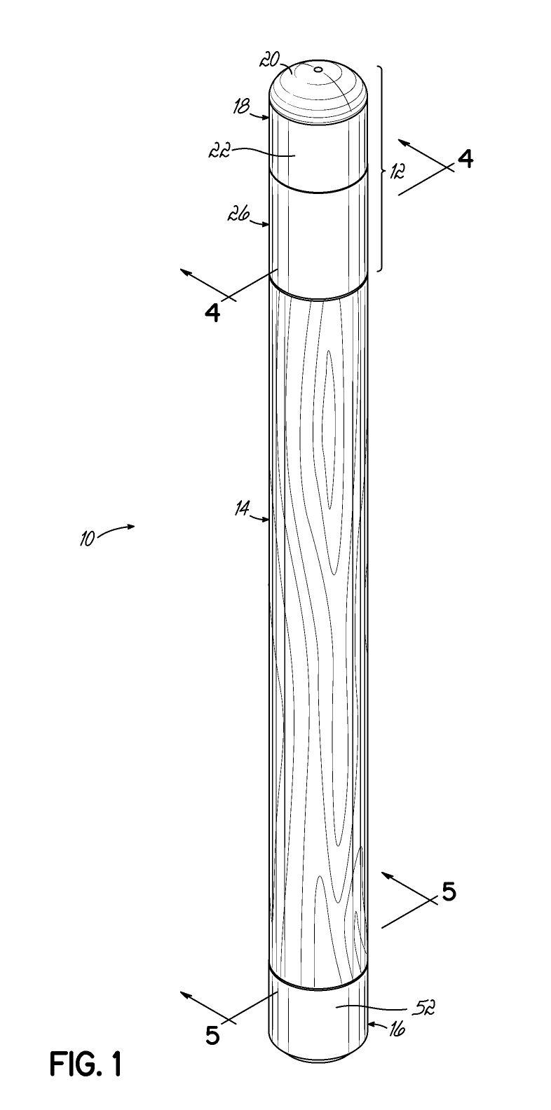

As shown in FIG. 1, the present invention is a fishing float 10, which is particularly suitable for fishing at night. Fishing float 10 is shown as a cigar slip float. However, the invention is not limited to the particular type of float and a variety of floats can incorporate the present invention.

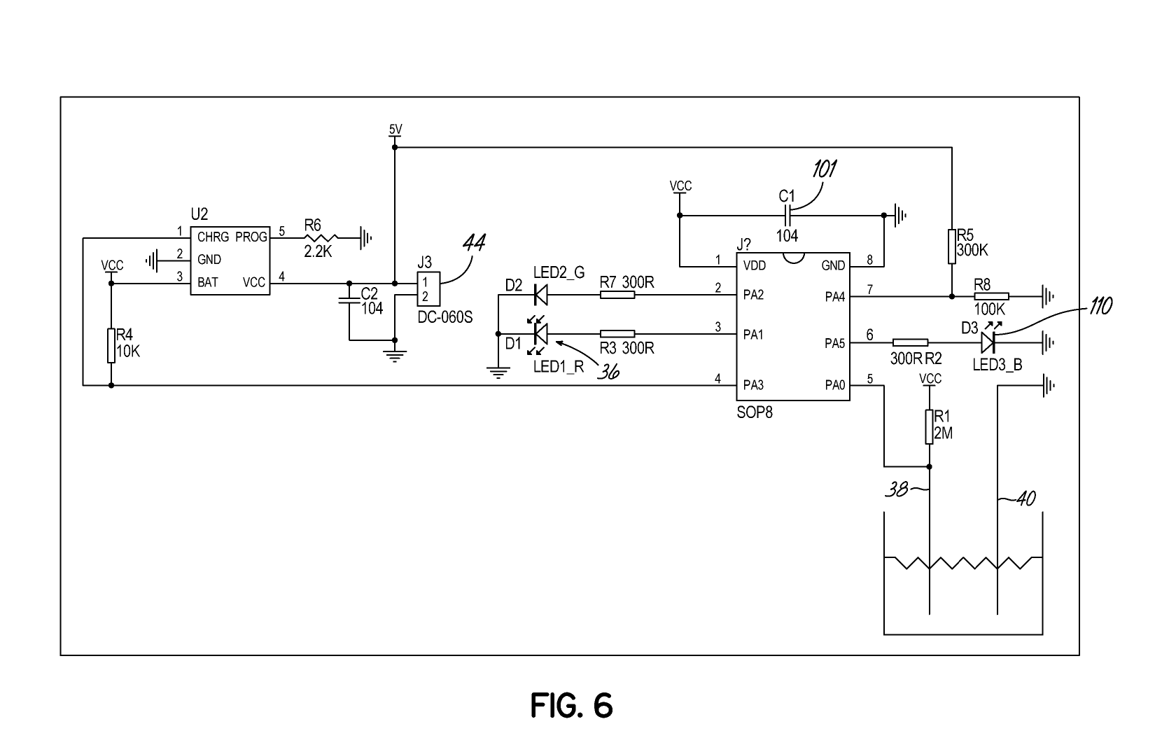

Fishing float 10 includes a top section 12, a middle section 14 and a bottom section 16. The top section 12 includes a cylindrical domed member 18 which includes an upper dome 20 and a cylindrical sidewall 22 having internal threading 24. The top section 12 further includes intermediate cylindrical member 26 which includes upper external threading 28 and lower internal threading 30 and has a hollow interior. Contained within the cylindrical member 26 is a circuit housing 32 which supports a circuit board 34 having first and second LEDs 36. The circuitry on circuit board 34 is shown in FIG. 6. First and second wires 38 and 40 extend from a bottom 41 of the circuit board 34. The circuit board 34 rests on top surface 42 of circuit housing 32. A charging port 44 extends through the external upper threading 28 of the cylindrical section 26, allowing a battery in the circuit board 34 to be charged. Circuit housing 32 includes a stepped cylindrical side wall 43 with a narrower bottom portion 45 fixed inside intermediate cylindrical member 26.

As assembled, the domed member 18 screws onto the cylindrical member 26 with the circuit housing 32 held therebetween. The assembled top section 12 is then threaded onto external threading 46 of the middle section 14 with an O-ring 48, maintaining a watertight seal.

In turn, the bottom section 16 includes a center wire holder member 50 and a hollow cylindrical end cap 52 which has internal threads 54 designed to attach to the external threading 56 of the middle section 14, holding the center wire holder 50 in position between an internal rim 53 of end cap 52 and the middle section 14. O-ring 58 ensures that the interior 62 of the middle section 14 is sealed from water.

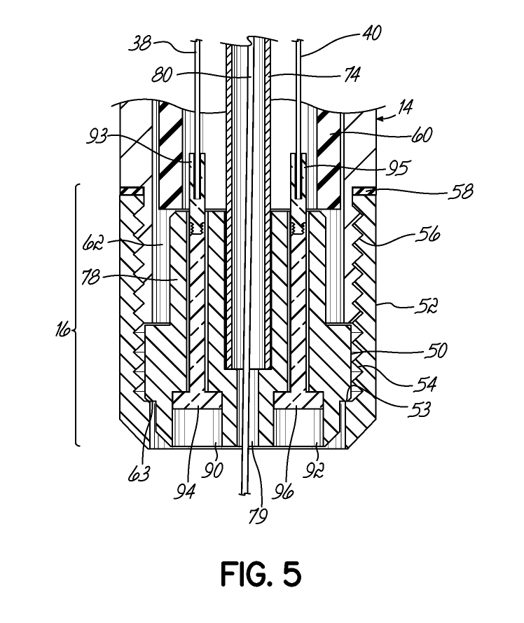

As shown in FIG. 5, a cylindrical weight 60 (optional) is located within the interior 62 of middle section 14. The end cap 52 screws onto the external threading 56 of the middle section 14, with an internal rim 53 engaging a shoulder 63 of wire holder 50, holding the center wire holder 50 in position in turn holding the weight 60 within the interior 62 of middle section 14.

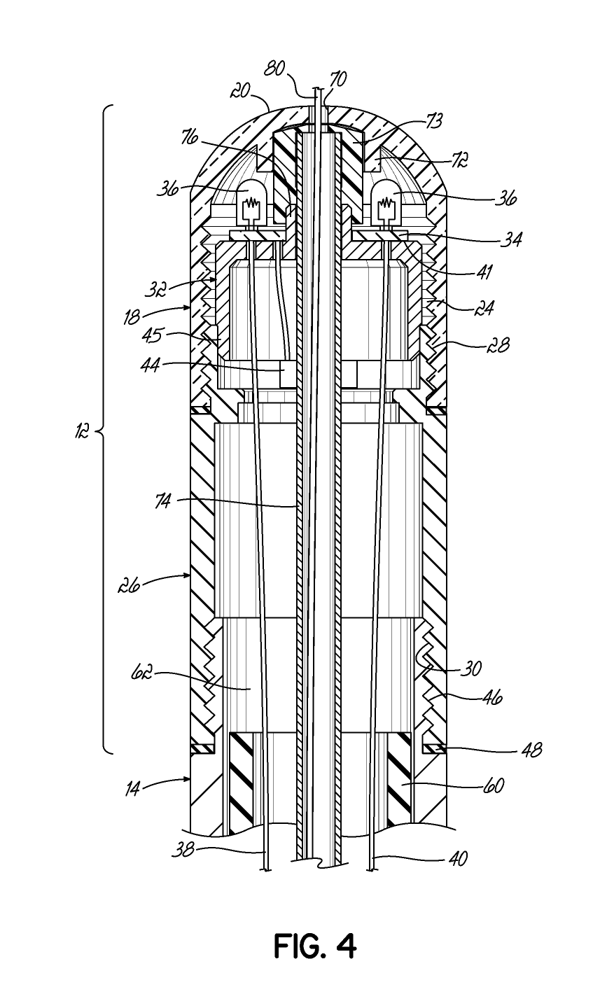

As shown in FIG. 4, the dome 20 of dome member 18 includes a top central hole 70 that extends to a tubular connection 72 fixed to the dome 20. A cylindrical connector 73 fits in connection 72 and receives a cylindrical extension 76 from circuit holder 32. A tube 74 fits within and attaches to the cylindrical extension 76. Tube 74 extends through the central section 14 to a tubular connector 78 located in the center wire holder 50 to a hole 79 in the central wire holder 50. This allows for a fishing line 80 to extend through the center of the fishing float 10 from the domed member 18 through the top section 12, middle section 14 and out the bottom section 16 and prevents water from the interior 62 of the float.

First and second wires 38 and 40 extend from a bottom portion 41 of the circuit board 34, through the interior of the middle section 14 to first and second portals 90 and 92. At portals 90 and 92 the wires are attached to metal leads 94 and 96, which are sealed to wire holder 50, preventing any water from entering the interior 62 of the float 10. Wires 38 and 40 attach to leads 94 and 96 with male/female connectors 93, 95, which allow the wire holder to be separated from wires 38 and 40. Wire holder 50 further includes recesses 102, 103 which are adapted to hold rubber plugs 104, 105 which are removable from the recesses and adapted to fit within the portals 90 and 92 to seal the metal leads 94 and 96 from water. The plugs and portals can be threaded so that the plugs can screw into portals 90, 92 to prevent water from accessing leads 94, 96.

The top, middle and bottom sections can be made from a variety of different materials. These include any plastic which is suitable for use in water and particularly injection moldable thermoplastic. The top section, in particular domed portion 18, is formed from a transparent or translucent material. The middle section can be formed from a thermoplastic or a composite material or even wood. Basically, any material which is sufficiently strong, is buoyant and can be formed into the desired shape by any means can be used.

The fishing float 10 is operated by simply attaching the float 10 to the fishing line 80 and casting it into the water. The exposed metal leads 94 and 96 will then contact the water and activate LEDs 36, as shown in circuit diagram FIG. 6. Thus, this will cause the LEDs 36 to light and allow the fishing float 10 to be detected in the dark. Optionally, only wire 40 which acts as a ground needs to contact the water to activate the LEDs 36.

As fishing continues, the fishing float 10 will periodically be withdrawn from the water which, in turn, will remove the metal leads from the water. A timing circuit 101 (capacitor as shown in FIG. 6) will keep the LEDs lit for a defined period of time after the float is removed from the water, for example, 30 seconds. Thus, when the fisherman pulls the float out the water to recast, the LEDs will remain on.

If the fisherman wants to use the float during the day without activating the lights, he simply takes the plugs 104 and 105 and inserts these into the portals 90 and 92, sealing the metal leads 94 and 96 from the water.

Fishing float 10 will have a power source, such as a battery, which will discharge during use. The battery can be recharged by separating the domed portion 18 from the cylindrical member 26. This exposes charging port 44. A cable (not shown) connected to a DC power source is plugged into the charging port 44, allowing the battery to be recharged. An overcharge circuit causes a third LED 110 to blink during charging until the battery is fully charged. LED 110 then remains on until the cable is separated from the float.

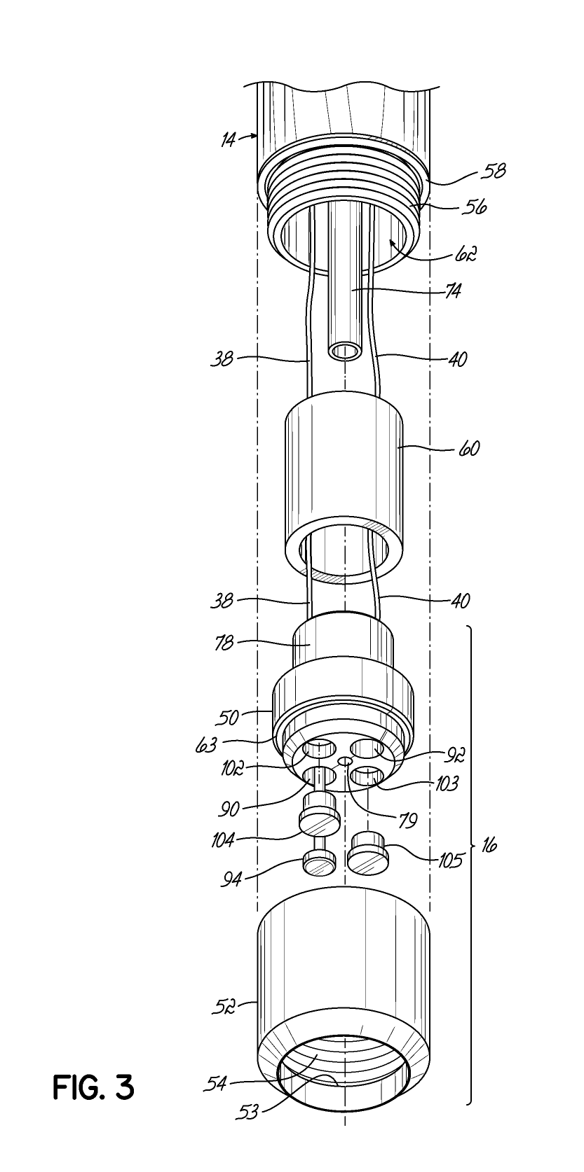

Further, as shown in FIGS. 3 and 5, the fishing float 10 may include a weight 60 which will cause the bottom section to be immersed in water with the float in a vertical position. Sometimes it is desirable for the float to be in a horizontal position. Therefore, weight 60 can be removed by simply removing the bottom section 16 by unscrewing end cap 52 and separating wire holder 50 from wires 38, 40. This allows the weight to slide out of the interior 62 of the middle section 14.

Thus, the fishing float 10 of the present invention provides a variety of different benefits. It allows a fisherman to fish at night and locate the float, where the float is automatically activated upon contacting water. The fisherman can periodically remove the float and recast his line without the light turning off every time the float is pulled from the water. Once the fisherman is done fishing, the float can be removed from the water and the lights will automatically turn off after a defined period of time. Also, if the fisherman desires to use the float during the daytime, plugs 104 and 105 can be inserted into portal 90, 92 to seal off metal leads 94 and 96 and prevent the LEDs 36 from being activated.

Finally, the present invention provides a removable weight, allowing a fisherman to use the float both in a weighted or a non-weighted condition, depending on the desires of the individual fisherman.

This has been a description the present invention along with the preferred method of practicing the present invention. However, the invention itself shall only be defined by the appended claims wherein I claim:

What is claimed is:

1. A fishing float having an exterior and interior;
a light and a power source for said light;
at least one conducting wire extending from within said interior of said float to the exterior of said float, said conducting wire effective to activate said light when in contact with water and deactivate said light when not in contact with water;
a timing circuit in communication with said light, which keeps the light activated for a defined period of time after said conducting wire is removed from said water.

2. The fishing float claimed in claim 1 having a top section, a bottom section and a middle section which are separable from each other, wherein said light and said power source are in said top section.

3. The fishing float claimed in claim 1 wherein said fishing float includes first and second conducting wires that extend from the interior of said float to the exterior of said float and activate said light when said wires are in contact with water.

4. The fishing float claimed in claim 3 wherein said first and second wires extend through portals in said bottom section of said float to the exterior of said float and further wherein said bottom section includes first and second plugs adapted to plug said portals to prevent said wires from contacting water.

5. The fishing float claimed in claim 2 wherein said power source is a rechargeable battery and wherein said top section includes a charging port and wherein said top portion includes first and second separable portions, wherein said charging port is exposed to said exterior when said first and second portions are separated.

6. The fishing float claimed in claim 2 wherein an interior of said middle section is at least partially hollow and further comprises a removable cylindrical weight in said interior of said middle section, said weight held in position by said bottom section.

7. A float having an interior and an exterior, further comprising:
a top section;
a middle section;
a bottom section;
each of said sections separable from each other; and
further comprising a weight in said middle section wherein removing said bottom section from said middle section allows said weight to be removed from said middle section.

8. The float claimed in claim 7 wherein said top section includes a light and a power source for said light.

9. The fishing float claimed in claim 8 wherein said fishing float further comprises at least a first conducting wire extending from within said float through the interior of said float to the exterior of said float, wherein upon cont acting water, said conducting wire activates said light and wherein said light is deactivated when said conducting wire is out of said water, wherein said wire extends through a center of said weight.

10. The fishing float claimed in claim 9 wherein said float further includes a timing circuit in communication with said light, which keeps said light activated for a defined period of time after said wire is removed from said water.

11. The fishing float claimed in claim 9 wherein said float includes first and second wires that act to activate said light and wherein said first and second wires extend to the exterior of said float at first and second portals and wherein said bottom section further includes first and second stored plugs which are effective to plug said portals, preventing said light from being activated when in water.

12. The fishing float claimed in claim 8 wherein said top section includes a first portion and a second portion which are detachable from each other and wherein said top portion includes a charging port effective to recharge said power source and wherein said charging port is exposed to said exterior when said first portion is separated from said second portion.

13. A fishing float having an exterior;
a light;
and further having a top section;
a middle section; and
a bottom section;
said top section having a light and a power source and said float further including conducting wires extending from said top section through said middle and bottom sections to first and second portals in said bottom sections;
wherein said light is activated when said first and second wires contact water;
said bottom section further including stored first and second plugs effective to plug said first and second portals, preventing said wires from contacting water.
